(19) United States
(12) Patent Application Publication
(10) Pub. No.: US 2022/0044461 A1
(43) Pub. Date: Feb. 10, 2022

(54) METHOD AND SYSTEM FOR GENERATING CUSTOM GREETING CARDS

(71) Applicants: Judith Lomax, Fairfield, ME (US); Tiffany Lomax, Washington, DC (US); Antoinette Mitchell, Washington, DC (US)

(72) Inventors: Judith Lomax, Fairfield, ME (US); Tiffany Lomax, Washington, DC (US); Antoinette Mitchell, Washington, DC (US)

(21) Appl. No.: 17/507,077

(22) Filed: Oct. 21, 2021

(51) Int. Cl. G06T 11/60; G06F 40/106; G06F 40/166; G06F 16/335; G06F 40/40

(52) U.S. Cl. CPC G06T 11/60; G06F 40/106; G06F 40/40; G06F 16/337; G06F 40/166

(57) ABSTRACT

A Greeting Card Platform that utilizes intellectual score data, suggested word or phrase input, custom messaging, personal photographs, and machine learning to generate a unique greeting card for an intended recipient is disclosed.

### CROSS-REFERENCE TO RELATED APPLICATION

Not Applicable.

### TECHNICAL FIELD

The present invention relates generally to the field of greeting card communications. More specifically, the present invention relates to a method and system for generating custom greeting cards.

### BACKGROUND

The tradition of sending and exchanging cards for holidays and special occasions dates back to the 15th century. In the 1850s, the general production and exchange of greeting cards became more common for all occasions. Greeting cards allows someone to express and share a range of human emotions while simultaneously allowing one to connect with someone else on an emotional level. From homemade greeting cards to greeting cards with photographs, the exchange of personalized greeting cards goes a step further by allowing someone to express personalized emotions and sentiments for another person such as family, friends, lovers, or even clients or employees. Greeting cards are also a way to share and capture memories with old friends, and to help someone keep those memories alive as they age.

Traditional paper greeting cards may be found in the isles of retail stores, the isles of grocery stores or even boutique card stores. As electronic communications became a more normalized form of communication, as did electronic greeting cards (e-cards). These e-cards, however, lacked the ability for the consumer to send greeting cards with the same personalized touch as homemade greeting cards. Traditional e-card platforms can also be challenging for elderly individuals to utilize effectively, particularly considering the fact that elderly individuals do not use email as efficiently and effectively as younger individuals thereby making it more difficult for an elderly individual to receive an e-card.

The problem of how to create custom greeting cards has been addressed in such disclosures such as U.S. Pat. No. 5,615,123 (and its progeny), which generally discloses a system for creating and producing custom card products. Although this disclosure allows a user to generate a custom greeting card, it does not, however, teach to a greeting card creation platform that allows a user to create the greeting card online, customize the greeting card with photographs and unique messages generated through machine learning.

Another attempt can be seen in disclosures such as U.S. Pat. No. 5,748,484 and U.S. Patent Application No. 2003/0004997 A1 which generally disclose a system for printing social expression cards in response to electronically transmitted orders. These disclosures do not, however, teach to a greeting card creation platform that allows a user to customize the greeting card with photographs and unique messages generated through machine learning.

While there exist many standalone kiosks at retail stores, or platforms that allow a user to create and print a customized greeting card, these systems are not capable of adapting the user interface to the age and intellectual capacity of the user, nor are these platforms capable of generating unique greeting card messaging through machine learning.

Various attempts have been made to solve the problems which may be found in the related art but have been unsuccessful. A need exists for a novel greeting card creation platform that utilizes machine learning to generate unique greeting card messages. The present invention provides for a method and system for generating custom greeting cards by factoring the age and intellectual capacity of the user and then generating unique greeting card messages through machine learning.

### BRIEF SUMMARY OF THE INVENTION

Certain embodiments commensurate in scope with the original claims subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed in the present disclosure by name, such as card, greeting card, message, and so forth, are herein meant to include or encompass all equivalents for such elements. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for a custom greeting card generating platform (“Greeting Card Platform”) by factoring the age and intellectual capacity of the user and then generating unique greeting card messages through machine learning. The general purpose of the present invention, which shall be described subsequently in greater detail, is to allow a user to generate a custom greeting card with a personalized message to the intended recipient.

The features of the invention which are believed to be novel and particularly pointed out and distinctly claimed in the concluding portion of the specification. These and other features, aspects, and advantages of the present invention will become better understood with reference to the following drawings and detailed description.

In an embodiment of the present invention, the Greeting Card Platform utilizes a least one server and a plurality of databases to house the platform and the platform data. To operate and engage the Greeting Card Platform, a user may access the Greeting Card Platform from a computer, laptop, or mobile device. Once the Greeting Card Platform has been accessed, a user may create a user profile and answers a series of questions, the answers to which are used generate and assign the user's intellectual score. The user's intellectual score data is stored in at least one database for the user's future use. The user is also prompted to input unique information about the intended card recipient. Users may then receive suggested words or phrases to include in the user's custom message or may, in the alternative, input his or her own unique message for the intended card recipient. In some embodiments, a user profile may be completed by the end user or, in instances where the end user has limited cognitive function or hand mobility, may be completed by an individual assisting the end user.

In a preferred embodiment of the present invention, the Greeting Card Platform may generate unique greeting card messages for the intended greeting card recipient based upon the user's profile data, intellectual score data, and unique information about the intended greeting card recipient. In other embodiments, the present invention may allow for the Greeting Card Platform to generate a unique greeting card with a truncated greeting card message that allows a user to handwrite a message for the intended recipient or, by way of non-limiting example, complete a sentence prompt such as “I remember when . . . ” or “Do you remember when . . . .” The Greeting Card Platform also allows a user to upload a unique photograph to be used as a cover or an insert to the customized greeting card for the intended greeting card recipient.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

### BRIEF DESCRIPTION OF THE DRAWINGS

FIG. 1 is a flow diagram illustrating the process steps for generating a custom greeting card in accordance with an embodiment of the present invention.

FIG. 2 is a flow diagram illustrating the process steps for generating and assigning an intellectual score in accordance with an embodiment of the present invention.

FIG. 3 is a flow diagram illustrating the process steps for generating custom greeting card messages in accordance with an embodiment of the present invention.

Numerous advantages and aspects of the invention will be apparent to those skilled in the art upon consideration of the following detailed description taken in conjunction with the drawings which generally provide illustrations of the invention in its preferred embodiments as they relate to greeting cards.

### DETAILED DESCRIPTION

While the invention will be described in connection with greeting cards, it is understood that the invention is not limited in scope to use with greeting cards but may be used with objects having other configurations.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

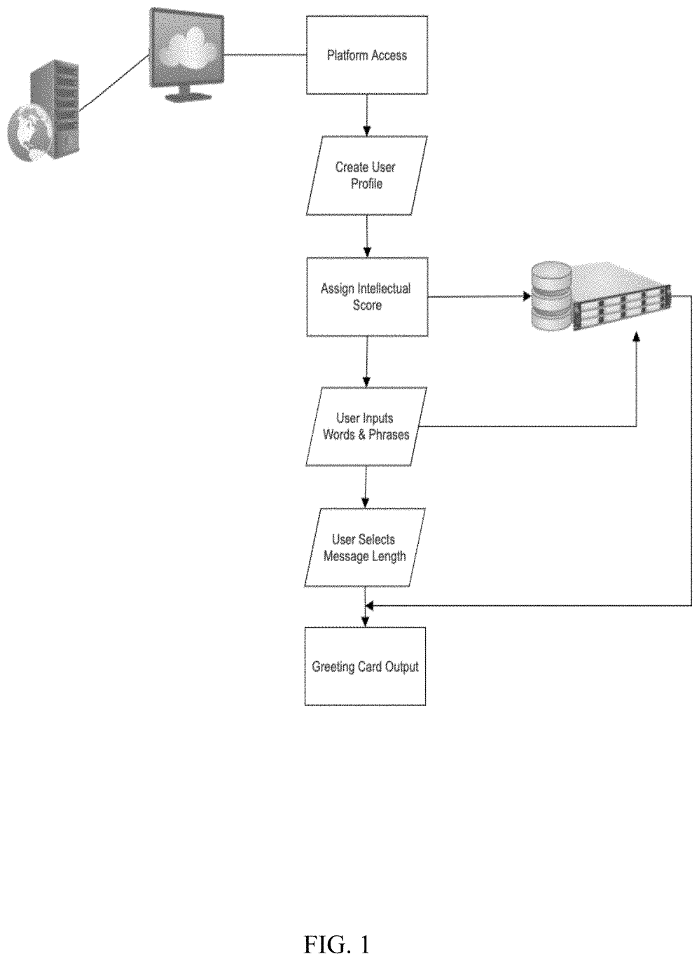

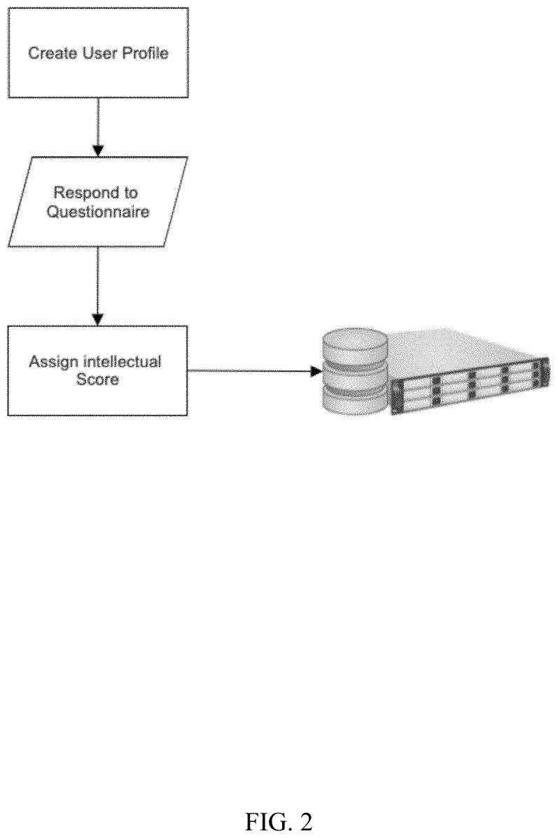

In FIG. 1, a flow diagram illustrating the process steps for generating a custom greeting card in accordance with an embodiment of the present invention is shown. In operation, the Greeting Card Platform 100 utilizes at least one server 101 that stores all platform data. A user may obtain platform access 103 by using a computer, laptop, or mobile device to login. A user may create a user profile 104 which may include information such as age, gender, geographical location, and the like. As described in more detail in FIG. 2, a user's user profile may also include the collection of data concerning a user's cognitive ability and intellectual capacity. The collective data from the user profile 104 is used to generate and assign the user's intellectual score 105, which may be stored in database 106.

While making the necessary selections related to the style of the greeting card, a user may input words and phrases 107 to include in the greeting card messaging, which are stored in the database 106. A user may then select the preferred greeting card message length 108.

In a preferred embodiment, the Greeting Card Platform 100 utilizes algorithms (not illustrated) to calculate a user's intellectual score 105 which, when analyzed against other user's intellectual scores 105, and constructs the empirical database 106 of intellectual score comparisons across all users in the Greeting Card Platform. By way of non-limiting example, a user's intellectual score 105 may be calculated (and recalculated) in view of the information provided by in the user's profile 104. Once recalculated, the machine learning algorithm of the present invention utilizes the empirical data to analyze and select the ideal greeting card messages based on the preferred greeting card message length 108, the empirical database 106 of intellectual score comparisons across all users of the Greeting Card Platform 100, resulting in a completed greeting card 109. In some embodiments, the greeting card message length may be auto-generated by the Greeting Card Platform 100 based on the calculated (or recalculated) intellectual score 105. These continuous recalculations enable a user to produce the most ideal greeting card for an intended recipient based on analytical and empirical data, as derived through machine learning.

Turning to FIG. 2 a flow diagram illustrating the process steps for generating and assigning an intellectual score is shown in accordance with an embodiment of the present invention. In the embodiment shown, a viewer may perceive that the following the creation of a user profile 104, a user will be required to respond to a questionnaire 201 comprising a plurality of questions aimed to derive a user's cognitive function and intellectual capacity 105. By way of non-limiting example, the present invention may allow for an elderly individual suffering from dementia or Alzheimer's access the Greeting Card Platform 100 to and will independently, and through machine learning, assess the user's ability to create a greeting card on his or her own, or may determine that the user requires more assistance with generating a greeting card.

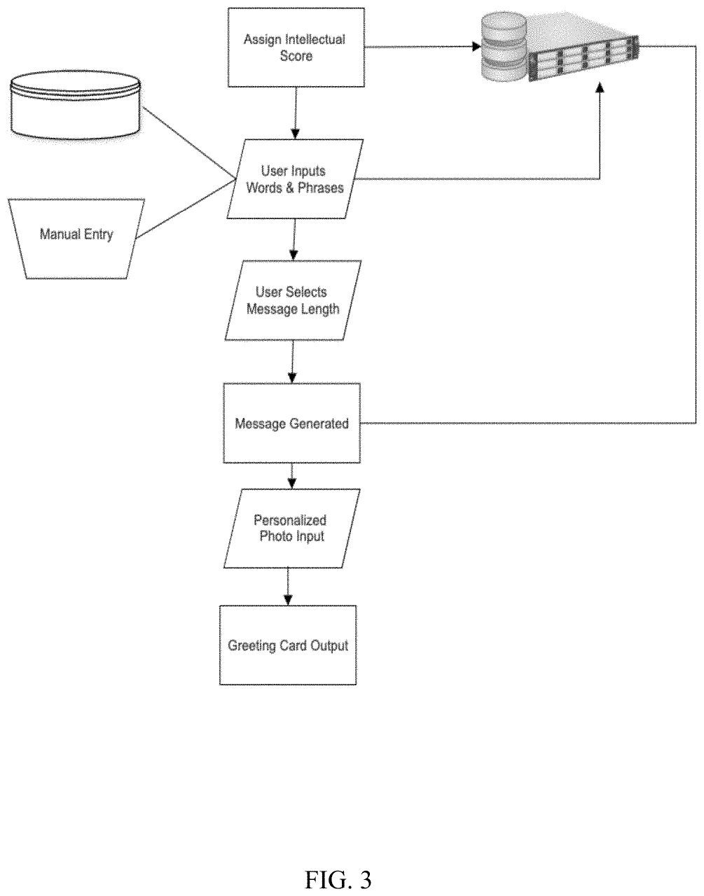

As seen in FIG. 3 the present invention may allow a user to input words or phrases 107 manually 302 or select pre-scripted words or phrase3 201 based on the user's cognitive ability and intellectual capacity. Such manual 302 inputs may include a description of a memory of the intended greeting card recipient or a personalized message. In some embodiments, a user may select a combination of manual 302 words and phrases 107 or pre-scripted 301 words and phrases 107. Along with the user's intellectual score 105 and the empirical data set of other intellectual scores of other users, a machine learning empirical database may generate the message 303 of the greeting card for the intended greeting card recipient.

In other embodiments, a user may be upload a photograph 304 of his or her choice to be used on the cover of the greeting card or as an insert. Following the generation of the greeting card message 303 and the upload of the photograph 304, the greeting card is generated 109 and mailed to the intended recipient.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the invention generally described herein has been disclosed in connection with a number of embodiments shown and described in detail, various modifications should be readily apparent to those of skill in the art.

What is claimed is:

1. A method for generating a custom greeting card, the method comprising the steps of:
determining the intellectual score of a plurality of users within the greeting card platform;
determining the intellectual score difference between a plurality of users with the greeting card platform;
accepting the input of words and phrases by a plurality of users;
accepting the input of at least one photograph by at least one user
generating a greeting card message of at least one greeting card for at least one intended greeting card recipient; and
generating at least one greeting card for at least one intended greeting card recipient.

2. The method of claim 1, whereby the intellectual score is numerical.

3. The method of claim 2, whereby the numerical representations of the intellectual score may be determined by a series of computations derived from empirical data, user input data, and quantifiable metric data.

4. The method of claim 2, whereby the numerical representation of the intellectual score and may be received as at least one sequence of data, wherein said sequence of data may be maintained in a historical database.

5. The method of claim 1, whereby the intellectual score of the plurality of users within the greeting card platform may be determined by at least one categorical data input the plurality of users.

6. The method of claim 5, whereby the at least one categorical data input is user self-assessment data.

7. The method of claim 1, whereby the user provides the greeting card platform with preferred words or phrases.

8. The method of claim 1, whereby the greeting card platform provides the user with optional words or phrases.

9. The method of claim 1, whereby the intellectual score divergence between a plurality of users may be determined by the calculation of the numerical difference between the intellectual score of at least one user as compared to the intellectual score of the remaining individual users.

10. The method of claim 1, whereby the generated greeting card message may be approved by an individual user.

11. The method of claim 1, whereby the generated greeting card message may be truncated thereby allowing an individual user to complete the greeting card message for the intended recipient.

12. The method of claim 1, whereby the intellectual score difference may be recalculated following the categorization of user-driven numerical input data.

13. The method of claim 1, whereby the user approves the greeting card.

14. A system for a generating a custom greeting card a greeting card platform, the method comprising the steps of:
one or more processors; and a data storage coupled to one or more processors, having instructions stored thereon which, when executed by at least one processor, causes the one or more processors to perform operations comprising:
receiving intellectual score data of at least two users within the greeting card platform; and
identifying the intellectual score difference between at least two users with the greeting card platform;

15. The system of claim 14, whereby the numerical representations of the intellectual score may be received as at least one sequence of data, wherein said sequence of data may be maintained in a historical database.

16. The system of claim 14, wherein the system is configured to classify the at least one sequence of data and the system is respectively trained to use the at least one sequence of data as a training data set.

17. The system of claim 14, whereby the system is configured to compute the divergence between the numerical representation and a second set of at least one other sequence of data, wherein the second set of at least one other sequence of data comprises the intellectual score of at least two users.

18. The system of claim 17, whereby the system analyzes the computed divergence between the numeric representation and the second set of at least one other sequence of data, and generates a greeting card message.

19. A non-transitory computer-readable medium stoting program that causes a processor to:
receive intellectual score data of at least two users within the greeting card platform;
identify the intellectual score difference between at least two users with the greeting card platform;
generate at least one greeting card message; and
generate at least one greeting card.
